(19) United States
(12) Patent Application Publication
(10) Pub. No.: US 2025/0121531 A1
(43) Pub. Date: Apr. 17, 2025

(54) WASTE PLASTIC GASIFICATION DEVICE AND WASTE PLASTIC GASIFICATION METHOD

(71) Applicant: Korea Institute of Energy Research, Daejeon (KR)

(72) Inventors: Chong Pyo CHO, Daejeon (KR); Joeng Geun KIM, Daejeon (KR); Jong Won CHOI, Daejeon (KR); Young Jin SHIN, Daejeon (KR); Seung Jea LEE, Daejeon (KR)

(73) Assignee: Korea Institute of Energy Research, Daejeon (KR)

(21) Appl. No.: 18/775,766

(22) Filed: Jul. 17, 2024

(30) Foreign Application Priority Data
Oct. 13, 2023 (KR) 10-2023-0137055

(51) Int. Cl. B29B 13/00; B29B 17/04

(52) U.S. Cl. CPC B29B 13/00; B29B 17/04; B29B 2013/005; B29B 2017/0468; B29B 2017/0496

(57) ABSTRACT

According to an embodiment of the present disclosure, there is provided a waste plastic gasification device including: a raw material input unit for inputting waste plastic raw materials; a first gasification unit that pyrolyzes the waste plastic raw materials at low temperatures using superheated steam to produce a mixed gas and preheats residual raw materials that have not been decomposed; a second gasification unit that further decomposes the preheated residual raw materials through plasma to produce the mixed gas; a residue discharge unit that stores and discharges waste plastic residual melt slag that has not been decomposed in the second gasification unit; and a heat exchange unit for cooling the mixed gas generated in the first gasification unit and the second gasification unit, wherein the second gasification unit is inclined in a direction of the residue discharge unit to discharge the waste plastic residual melt slag.

### CROSS REFERENCE TO RELATED APPLICATION

This application claims the benefit of and priority to Korea Patent Application No. 10-2023-0137055, filed on Oct. 13, 2023, the entire disclosure(s) of which is hereby incorporated herein by reference in its entirety.

### FIELD OF TECHNOLOGY

The present disclosure relates to a waste plastic gasification device and a waste plastic gasification method for effectively gasifying waste plastics.

### BACKGROUND

Plastics refer to a polymer compound made by combining raw materials extracted from petroleum. The plastics have various types and properties depending on its components, combination of ingredients, and manufacturing method. The plastics may be broadly divided into two types: thermoplastic and thermosetting plastics.

The thermoplastic plastic refers to a plastic that, when heated, bonds between molecules configuring the plastic become weak and the plastic has fluidity, and the plastic returns to a solid state when the temperature is lowered again. The thermosetting plastic refers to a plastic that, when heated, does not have fluidity like the thermoplastic plastic, but burns into a powder or generates gas.

A thermoplastic (combustible) waste plastic is classified as solid reuse fuel (SRF) and may be incinerated in a waste-to-energy facility and used for steam production and power generation. The SRF varies depending on its composition, but according to thermogravimetric Analysis (TGA), the SRF may generally be decomposed by 70% or more at 600° C. or less.

According to the TGA of a thermosetting waste plastic in a nitrogen atmosphere, phenol resin and melamine resin are decomposed by 50% to 70% at about 400° C., but urea resin is decomposed only by 20%, showing that urea resin is not completely decomposed under normal combustion temperature conditions (approximately 1,000° C. or lower). Accordingly, the thermosetting waste plastics may be processed using high-temperature gasification technology using plasma.

Plastics are widely used in daily necessities due to their advantages of being light, strong, and easy to mold by applying heat, and a lot of waste plastics are also generated around the world.

To prevent environmental pollution and recycle resources, technology is being developed to extract raw materials using waste plastics, among which technologies for generating hydrogen and chemical raw materials by gasifying waste plastics are being actively researched and developed.

Gasification is a partial reduction process that is achieved by adding less oxygen than the theoretical amount of oxygen needed for combustion of organic materials at high temperatures, and the products are mainly H₂, CO, CO₂, CH₄ and hydrocarbons.

The minimum amount of oxidizing agent needed for gasification may be supplied through air, oxygen gas, steam, or CO₂, an inert gas.

Among waste plastic gasification technologies, the method using high-temperature plasma uses a plasma torch that generates ionized high-temperature gas with an internal temperature of 5,000° C. or higher through local gasification. As this method uses very high temperatures, most organic matter may be converted into gas.

Research and development have recently been underway on devices that continuously supply and gasify waste plastic raw materials. Continuous waste plastic gasification devices have the advantage of being able to process waste plastics with higher efficiency than batch-type waste plastic gasification devices. However, there is an issue in that waste plastic residual melt slag generated during the gasification process needs to be continuously discharged.

Accordingly, there is a need to develop a technology that may increase the efficiency of waste plastic gasification by constantly and continuously supplying waste plastic raw materials while continuously discharging waste plastic residual melt slag.

The discussions in this section are only to provide background information and do not constitute an admission of prior art.

### SUMMARY

From this background, an aspect of the present disclosure is directed to providing a waste plastic gasification device for effectively discharging waste plastic residual melt slag

In addition, another aspect of the present disclosure is directed to providing a waste plastic gasification device capable of constantly and continuously supplying waste plastic raw materials.

In addition, yet another aspect of the present disclosure is directed to providing a waste plastic gasification method capable of continuously gasifying waste plastics.

An embodiment may provide a waste plastic gasification device including: a raw material input unit for inputting waste plastic raw materials; a first gasification unit that pyrolyzes the waste plastic raw materials at low temperatures using superheated steam to produce a mixed gas and preheats residual raw materials that have not been decomposed; a second gasification unit that further decomposes the preheated residual raw materials through plasma to produce the mixed gas; a residue discharge unit that stores and discharges waste plastic residual melt slag that has not been decomposed in the second gasification unit; and a heat exchange unit for cooling the mixed gas generated in the first gasification unit and the second gasification unit, wherein the second gasification unit is inclined in a direction of the residue discharge unit to discharge the waste plastic residual melt slag.

The raw material input unit may include a hopper that stores the waste plastic raw materials, and the hopper may include a crushing unit that crushes the waste plastic raw materials.

The first gasification unit may include a variable pitch screw device for constantly and continuously supplying and transporting the waste plastic raw materials.

The variable pitch screw device may be disposed in a direction parallel to a transport direction of the waste plastic raw materials.

The waste plastic raw materials may move inside the variable pitch screw case, and the superheated steam may move outside the variable pitch screw case, wherein moving directions of the waste plastic raw materials and the superheated steam may be in opposite directions from each other.

The superheated steam may be 600 to 700° C.

The second gasification unit may include an arc plasma device for supplying heat.

The second gasification unit may be provided in a cylindrical shape so that the heat supplied from the arc plasma device may be uniformly distributed, and may be disposed at an angle of 15 to 25° with the ground surface.

An internal temperature of the second gasification unit may be 1,200 to 1,500° C.

The residue discharge unit may include a water tank storing cooling water for cooling the waste plastic residual melt slag that has not been decomposed in the second gasification unit.

Another embodiment may provide a waste plastic gasification method including: a raw material input stage of crushing waste plastic raw materials and inputting the same into a first gasification unit; a first gasification stage of pyrolyzing the input waste plastic raw materials at low temperatures using superheated steam in the first gasification unit and preheating residual raw materials that have not been decomposed; a second gasification stage of further decomposing the preheated residual raw materials through plasma in a second gasification unit; a residue discharge stage of storing and discharging waste plastic residual melt slag that has not been decomposed in the second gasification stage; and a heat exchange stage of cooling a mixed gas generated in the first gasification stage and the second gasification stage, wherein the waste plastic residual melt slag is transported to a residue discharge unit along an inclined direction of the second gasification unit.

In the first gasification stage, the waste plastic raw materials may be constantly and continuously supplied and subjected to low-temperature pyrolysis.

The first gasification stage may be performed at 350 to 450° C.

The second gasification stage may be performed at 1,200 to 1,500° C.

The residue discharge stage may include a cooling stage of water cooling the waste plastic residual melt slag to room temperature.

Yet another embodiment may provide a waste plastic gasification system including: a first gasification unit that pyrolyzes waste plastic raw materials at low temperatures using superheated steam to produce a mixed gas and preheats residual raw materials that have not been decomposed; a second gasification unit that further decomposes the preheated residual raw materials through plasma to produce the mixed gas; and a residue discharge unit that stores and discharges waste plastic residual melt slag that has not been decomposed in the second gasification unit.

The second gasification unit may be inclined in a direction of the residue discharge unit to discharge the waste plastic residual melt slag.

The first gasification unit may include a variable pitch screw device for constantly and continuously supplying and transporting the waste plastic raw materials.

The superheated steam may be 600 to 700° C.

An internal temperature of the second gasification unit may be 1,200 to 1,500° C.

According to an embodiment of the present disclosure, the waste plastic residual melt slag can be effectively discharged and waste plastics can be continuously gasified.

In addition, according to an embodiment of the present disclosure, the efficiency of waste plastic gasification can be improved by constantly and continuously supplying waste plastic raw materials.

The aspects of the present disclosure are not limited to those mentioned above, and other aspects not mentioned herein will be clearly understood by those skilled in the art from the following description.

### BRIEF DESCRIPTION OF THE DRAWINGS

In order for the disclosure to be well understood, the drawings are described in various forms and given by way of example, and references are made to the accompanying drawings.

FIG. 1 is a diagram illustrating a waste plastic gasification device according to an embodiment.

FIG. 2 is a configuration diagram illustrating a waste plastic gasification device according to an embodiment.

FIG. 3 is a configuration diagram illustrating the movement of a mixed gas generated in a waste plastic gasification device according to an embodiment.

FIG. 4 is a configuration diagram illustrating the movement of waste plastic residual melt slag generated in a waste plastic gasification device according to an embodiment.

FIG. 5 is a diagram illustrating a raw material input unit according to an embodiment.

FIG. 6 is a diagram illustrating a first gasification unit according to an embodiment.

FIG. 7 is a diagram illustrating a vertical cross-section of the first gasification unit according to an embodiment.

FIG. 8 is a diagram illustrating a variable pitch screw device of the first gasification unit according to an embodiment.

FIG. 9 is a diagram illustrating a side surface of a second gasification unit according to an embodiment.

FIG. 10 is a diagram illustrating a front surface of the second gasification unit according to an embodiment.

FIG. 11 is a diagram illustrating a residue discharge unit according to an embodiment.

FIG. 12 is a flowchart of a waste plastic gasification method according to an embodiment.

### DETAILED DESCRIPTION

Hereinafter, some embodiments of the present disclosure will be described in detail with reference to exemplary drawings. It is to be noted that in assigning reference numerals to respective elements in the drawings, the same reference numerals designate the same elements although the elements are shown in different drawings. Furthermore, in describing the present disclosure, a detailed description of the related known functions and constructions will be omitted if it is deemed to make the gist of the present disclosure vague.

Furthermore, in describing the elements of the present disclosure, terms, such as the first, second, A, B, a, and b, may be used. However, the terms are used to only distinguish one element from the other element, but the essence, order, and sequence of the elements are not limited by the terms. Furthermore, in the case in which one element is described to be “connected,” “coupled,” or “joined” to the other element, the one element may be directly connected or coupled to the other element, but it should be understood that a third element may be “connected,” “coupled,” or “joined” between the two elements.

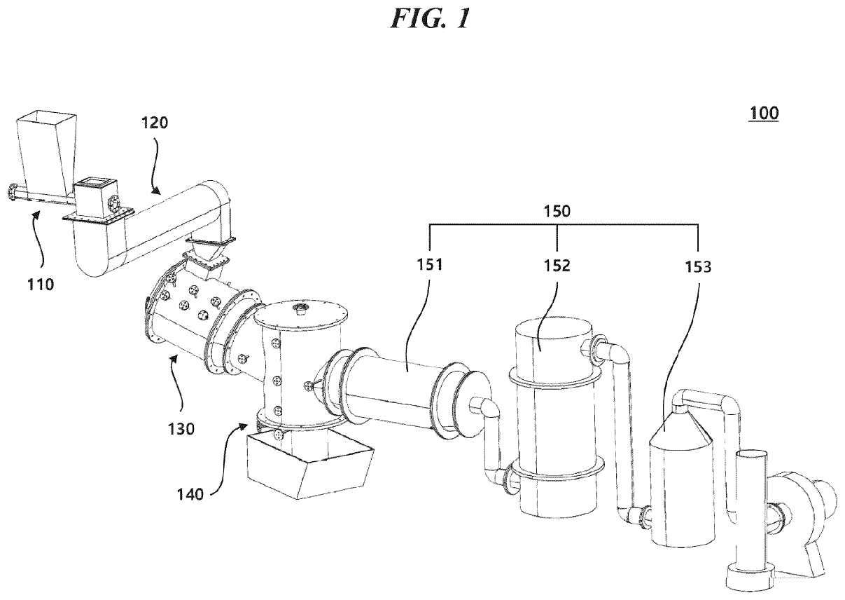

FIG. 1 is a diagram illustrating a waste plastic gasification device according to an embodiment.

Referring to FIG. 1, a waste plastic gasification device 100 according to an embodiment of the present disclosure may include a raw material input unit 110, a first gasification unit 120, a second gasification unit 130, a residue discharge unit 140, and a heat exchange unit 150.

The disposition and connection relationships of each component illustrated in FIG. 1 are exemplary, and the addition, removal, and changes of components and disposition may be applied in various ways as needed.

The raw material input unit 110 may input raw materials into a gasification unit for gasifying waste plastic raw materials. The waste plastic raw materials may include thermoplastic and thermosetting plastics. Specifically, the waste plastic raw materials may include widely used plastics such as polyethylene (PE), polypropylene (PP), polystyrene (PS), and polyvinyl chloride (PVC).

The raw material input unit 110 may include a crushing device for crushing waste plastic raw materials. Thus, the waste plastics may be pulverized into fine particles and the reaction area in the gasification unit may be expanded to effectively gasify the waste plastics.

The first gasification unit 120 may produce a mixed gas by gasifying waste plastic raw materials using superheated steam 121. The superheated steam may have a temperature of 600 to 700° C. by reheating steam generated through a waste heat boiler burner. Since the superheated steam 121 is supplied after being reheated, the temperature may be maintained constant and energy may be uniformly transferred to the first gasification unit 120.

The superheated steam 121 may have a temperature of 600° C. or higher, 625° C. or higher, and 650° C. or higher, and may have a temperature of 700° C. or lower. Specifically, the superheated steam 121 may have a temperature of 600 to 700° C., and preferably may have a temperature of 699° C.

Heat energy is transferred into the first gasification unit 120 through the superheated steam of 600 to 700° C., and the internal temperature of the first gasification unit 120 may be 350 to 450° C. In other words, since the first gasification 120 pyrolyzes waste plastic raw materials at low temperatures, 10 to 25% of the waste plastic raw materials may be gasified through the first gasification unit 120.

The residual waste plastic raw materials remaining after being gasified in the first gasification unit 120 may not be in the form of fluff but in the form of compressed solids in which the volatile content has been partially decomposed. When these residual waste plastic raw materials are input into the second gasification unit 130 and gasified, suspended solids may be minimized. Moreover, it may be easy to intensively gasify intermediate residues in a high temperature area of the plasma torch flame and the high temperature area of the gasification furnace surface. Additionally, waste plastics that undergo primary thermal decomposition may reduce the energy needed for the secondary gasification reaction.

The second gasification unit 130 may produce a mixed gas by further decomposing the waste plastic residual raw materials that have not been decomposed in the first gasification unit 120 through plasma. Plasma may be generated from the arc plasma device to generate a flame inside the second gasification unit 130. Thus, the internal temperature of the second gasification unit 130 may be 1,200 to 1,500°° C. More than 75% of waste plastic raw material may be gasified through the second gasification unit 130.

The internal temperature of the second gasification unit 130 through the flame generated from the arc plasma device may be 1,200° C. or higher, 1,225° C. or higher, 1,250° C. or higher, 1,275° C. or higher, and 1,300° C. or higher, and 1,500° C. or lower, 1,475° C. or lower, 1,450°° C. or lower, 1,425° C. or lower, and 1,400°° C. or lower. Preferably, the internal temperature of the second gasification unit 130 may be 1,300 to 1,400° C.

The second gasification unit 130 may be disposed in a shape inclined in the direction of the residue discharge unit 140 to facilitate the discharge of waste plastic residual melt slag, which is residual inorganic matter remaining without gasification. An embodiment of the present disclosure relates to a device capable of continuously supplying and gasifying waste plastic raw materials, and it is important to continuously discharge the generated waste plastic residual melt slag. Accordingly, according to an embodiment of the present disclosure, the second gasification unit 130 may be disposed in an inclined shape so that waste plastic residual melt slag may be continuously discharged through the residue discharge unit 140.

The mixed gas produced in the first gasification unit 120 and the second gasification unit 130 may be carbon monoxide (CO), carbon dioxide (CO₂), methane (CH₄), and hydrogen (H₂). Specifically, the following chemical reaction may occur inside the first gasification unit 120 and the second gasification unit 130.

C+O₂->CO₂ [Chemical Formula 1]

2C+O₂->2CO [Chemical Formula 2]

C+CO₂->2CO [Chemical Formula 3]

C+H₂O->CO+H₂ [Chemical Formula 4]

C+2H₂O->CO₂+2H₂ [Chemical Formula 5]

C+2H₂->CH₄ [Chemical Formula 6]

CO+H₂O->CO₂+H₂ [Chemical Formula 7]

CH₄+H₂O-22 CO+3H₂ [Chemical Formula 8]

In an embodiment of the present disclosure, waste plastic raw materials are decomposed and gasified in stages by dividing the same into the first gasification unit 120 and the second gasification unit 130, so that the load on the entire waste plastic gasification device 100 may be distributed.

Specifically, when waste plastic raw materials at room temperature are directly pyrolyzed at high temperatures, the gasification efficiency of the waste plastic raw materials may decrease, an excessive load may be generated on the waste plastic gasification device itself, and the device may become bulky. However, the waste plastic gasification device 100 according to an embodiment of the present disclosure first performs low-temperature pyrolysis in the first gasification unit 120 and then performs high-temperature pyrolysis using plasma in the second gasification unit 130. Accordingly, the gasification efficiency of the waste plastic raw materials may be increased, and moreover, the load on the waste plastic gasification device 100 may be distributed and lowered.

Since the gasification reaction of waste plastics is an endothermic reaction, a continuous supply of heat energy is needed to efficiently proceed with the gasification reaction. In particular, it is essential to maintain a high temperature in the process of gasifying waste plastics. This is because converting waste plastics into gas through a gasification reaction requires a significant amount of energy to be absorbed during the reaction.

Various auxiliary heat source devices may be used to supply the heat energy needed for this gasification reaction. The waste plastic gasification device 100 according to an embodiment may include at least one of a plasma torch or an oxygen burner to supply heat energy needed for the gasification reaction of waste plastics.

A plasma torch is a device that generates plasma at a very high temperature using electrical energy. Plasma is an ionized gas that has a much higher temperature than a typical flame, providing sufficient heat to quickly and efficiently gasify waste plastics. The plasma torch generates plasma through an electric arc, and the extremely high temperatures generated during this process may promote the decomposition of waste plastics and help maintain the high-temperature gasification reaction.

The plasma torch uses gas to eject the electric arc generated inside the torch out of the

torch, and nitrogen is generally utilized. The electric arc maintains a high-temperature plasma state generated by electrical discharge between electrodes, and the nitrogen used at this connection plays a role in maintaining the plasma stably.

However, when a large amount of nitrogen is used, the concentration of nitrogen in the synthesis gas produced in the gasification reaction increases. This can cause several issues in the gasification process. For example, high nitrogen concentration in synthesis gas may reduce the efficiency of the WGS (Water Gas Shift, CO+H₂O→H₂+CO₂) reaction process that converts CO to H₂. Additionally, in the PSA (Pressure Swing Adsorption) process that separates hydrogen, the burden of the process increases when the nitrogen concentration is high. Accordingly, it may be advantageous to minimize nitrogen usage.

Accordingly, when the plasma torch is used, the waste plastic gasification device 100 according to an embodiment divides the arc into a first gas that separates the arc from an electrode unit and a second gas that ejects the separated arc out of the torch. In this connection, CO₂ generated in the gasification process may be recycled and used as a second gas.

CO₂ may be decomposed into CO and O₂ under high temperature conditions of thousands of K or more in a plasma torch flame unit. This helps increase synthesis gas production while supplying the oxidant needed for the gasification reaction. By using CO₂ in this process, the nitrogen concentration in the synthesis gas may be reduced and the burden of WGS and PSA processes may be reduced.

In addition, not only CO₂ may be used as the second gas, but also a mixture of CO₂ and N₂ may be used. By properly mixing CO₂ and N₂, the efficiency of the gasification process may be maximized while maintaining the stability of the plasma torch. This approach may contribute to increasing the operating efficiency of plasma torches and implementing an environmentally friendly gasification process.

The oxygen burner is a device that generates a high-temperature flame by reacting pure oxygen and fuel. Using the oxygen burner, it is possible to obtain a flame at a much higher temperature than when using regular air. This is because the higher oxygen concentration increases combustion efficiency. The oxygen burner helps the gasification reaction proceed smoothly by providing the heat necessary for a waste plastic gasification reactor.

The oxygen burner uses at least one of LPG (liquefied petroleum gas) or LNG (liquefied natural gas) as fuel, and uses pure oxygen instead of general air as an oxidizing agent. As the oxygen concentration increases, the adiabatic flame temperature rises rapidly, reaching thousands of K or more. The high-temperature flame is very effective in gasifying waste plastics.

The waste plastic gasification device 100 according to an embodiment uses the oxygen burner, and may be used by mixing CO₂ with oxygen. When CO₂ is mixed with oxygen instead of nitrogen, CO₂ decomposes into CO and O₂ in a high-temperature flame. Accordingly, it is possible to provide a similar benefit as when using the plasma torch.

In particular, the waste plastic gasification device 100 according to an embodiment may recirculate CO₂ generated in the gasification process, mix the same with pure oxygen, and use the same as an oxidizing agent in the oxygen burner. Thus, CO₂ generated in the gasification process may be efficiently recycled, and the process may be operated without additional external CO₂ supply. This may contribute to reducing the environmental impact of the gasification process and improving economic feasibility.

Specifically, the composition of the mixed gas to be used as an oxidizing agent may range from using only O₂ to mixing up to 75% of CO₂. By adjusting the CO₂ ratio as such, flame temperature and oxidation conditions may be optimized, thereby maximizing the efficiency of the gasification reaction. For example, the use of a high CO₂ ratio may lower the flame temperature appropriately to provide sufficient oxidant supply while maintaining reactor durability.

Additionally, the use of a mixture of CO₂ and O₂ helps control the oxidizing atmosphere in the reactor. CO₂ is an oxidizing agent and acts as an inert gas to a certain extent, and thus may improve the quality of the synthesis gas produced in the gasification process and prevent unnecessary introduction of nitrogen.

Accordingly, the waste plastic gasification device 100 according to an embodiment improves the efficiency of the gasification process while maintaining a high temperature and stable flame by using a mixture of CO₂ and O₂ as an oxidizing agent when the oxygen burner is used. Thus, an environmentally friendly and economical waste plastic gasification process may be implemented.

The waste plastic residual melt slag that has not been decomposed in the first gasification unit 120 and the second gasification unit 130 may be stored and discharged through the residue discharge unit 140. In an embodiment of the present disclosure, since waste plastic raw materials are constantly and continuously input and gasified, the resulting waste plastic residual melt slag is continuously discharged from the residue discharge unit 140.

Cooling water for cooling the waste plastic residual melt slag may be provided in a water tank included in the residue discharge unit 140. Thus, the waste plastic residual melt slag may be cooled and discharged to the outside. The inflow of air into the second gasification unit 130 from the outside may be blocked through the cooling water provided in the water tank of the residue discharge unit 140. To this end, since a certain level of cooling water needs to be maintained in the water tank of the residue discharge unit 140, a cooling water supply device for water level adjustment that supplies the cooling water may be connected to a side surface of the water tank of the residue discharge unit 140.

The waste plastic residual melt slag discharged through the residue discharge unit 140 is mostly an inorganic matter, and may be contained in 10% or less of waste plastic raw materials, preferably contained in 2 to 8% of the waste plastic raw materials, and more preferably contained in 5 to 7% of the waste plastic raw materials.

The mixed gas generated in the first gasification unit 120 and the second gasification unit 130 may be cooled through the heat exchange unit 150 and transported to a hydrogen collection unit. The heat exchange unit 150 may include a first heat exchanger 151, which is a horizontal heat exchanger, a second heat exchanger 152, which is a vertical heat exchanger, and an auxiliary heat exchanger 153. Thus, the mixed gas may be cooled to 30 to 50° C., which is the optimal temperature for hydrogen collection.

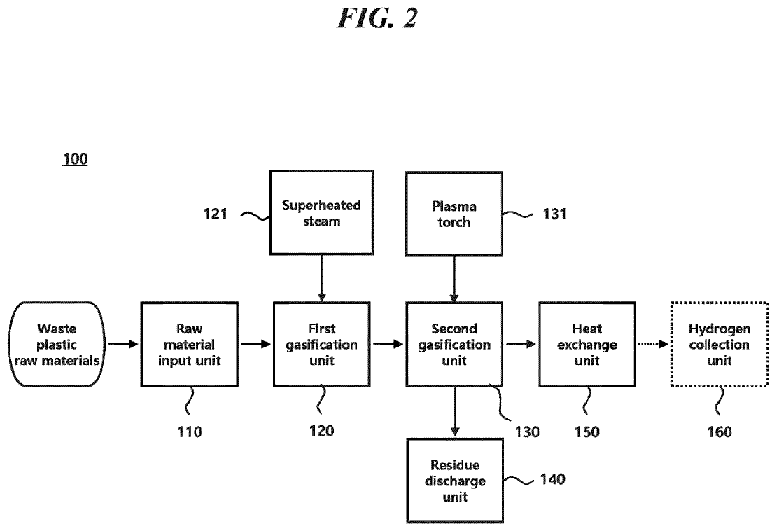

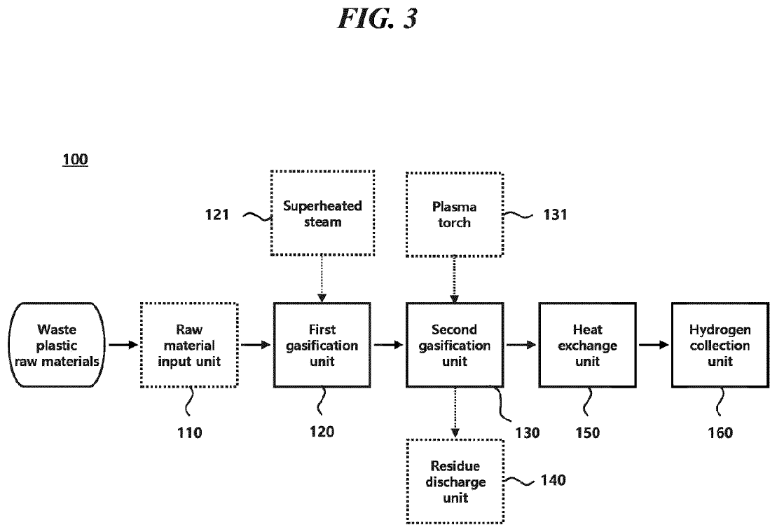

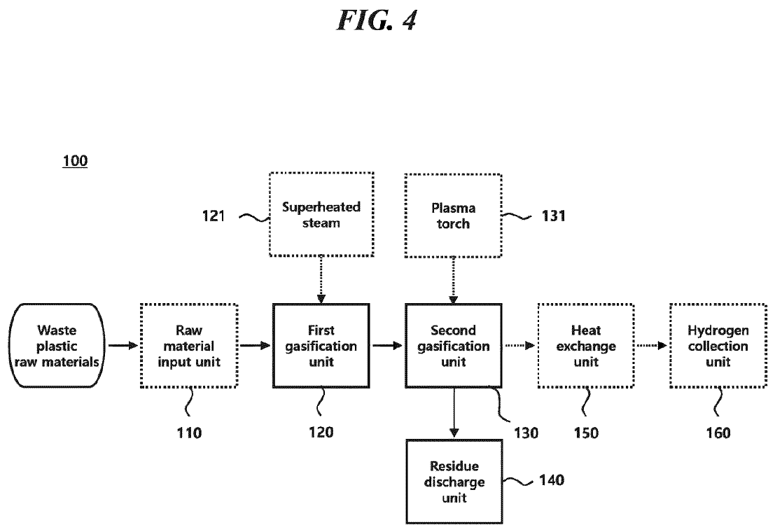

FIG. 2 is a configuration diagram illustrating a waste plastic gasification device according to an embodiment. FIG. 3 is a configuration diagram illustrating the movement of a mixed gas generated in a waste plastic gasification device according to an embodiment. FIG. 4 is a configuration diagram illustrating the movement of waste plastic residual melt slag generated in a waste plastic gasification device according to an embodiment.

Referring to FIGS. 2 to 4, the relationship between each component of the waste plastic gasification device 100 according to an embodiment of the present disclosure may be identified. Specifically, the waste plastic gasification device 100 may include the raw material input unit 110, the first gasification unit 120, the second gasification unit 130, the residue discharge unit 140, and the heat exchange unit 150, wherein the mixed gas produced through the waste plastic gasification device 100 may be transported to a hydrogen collection unit 160 to extract and collect hydrogen.

The first gasification unit 120 and the second gasification unit 130 may produce a mixed gas by gasifying waste plastic raw materials, and the produced mixed gas may be cooled to 30 to 50° C. through the heat exchange unit 150 and then may be transported to the hydrogen collection unit 160. Herein, the mixed gas produced in the first gasification unit 120 and the second gasification unit 130 may be carbon monoxide (CO), carbon dioxide (CO₂), methane (CH4), and hydrogen (H₂), and after being cooled through the heat exchange unit 150, hydrogen may be extracted and collected in the hydrogen collection unit 160.

The waste plastic residual melt slag generated in the first gasification unit 120 and the second gasification unit 130 may be discharged through the residue discharge unit 140 connected to the second gasification unit 130. Herein, the waste plastic residual melt slag may be mostly an inorganic matter, and may be melted in the second gasification unit 130 and moved to the residue discharge unit 140. The second gasification unit 130 may be inclined in order to effectively and continuously discharge the generated waste plastic residual melt slag. Additionally, the discharged waste plastic residual melt slag may be recycled for other purposes.

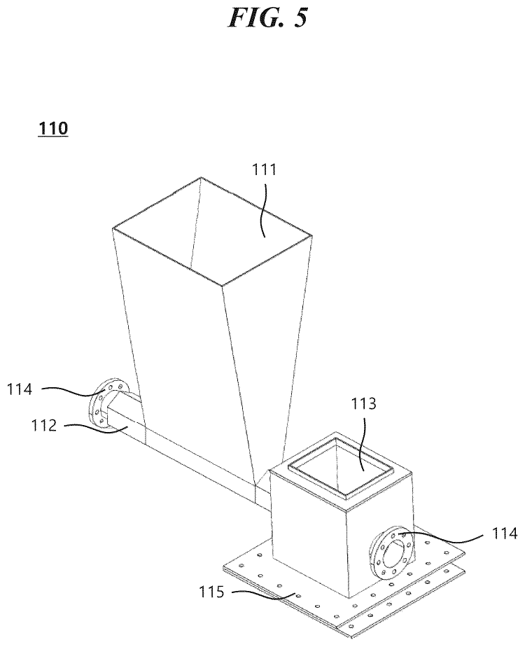

FIG. 5 is a diagram illustrating a raw material input unit according to an embodiment.

Referring to FIG. 5, the raw material input unit 110 may include a hopper 111, a raw material conveying pipe 112, a raw material input pipe 113, a raw material conveying pipe flange 114, and a raw material input unit flange 115.

The hopper 111 may store waste plastic raw materials, and the hopper 111 may include a crushing unit (not shown) that crushes the supplied waste plastic raw materials. Thus, the waste plastic raw materials may be crushed into fine particles to expand the reaction area in the first gasification unit 120 so as to effectively perform pyrolysis at low temperatures. The crushing unit (not shown) may include a rotating device provided with a plurality of hammers. The waste plastic raw materials continuously supplied through the rotating device included in the crushing unit (not shown) may be continuously crushed and input into the first gasification unit 120.

Waste plastic raw materials may be conveyed through the raw material conveying pipe 112 disposed at a lower end of the hopper 111 and input into the first gasification unit 120 through the raw material input pipe 113. The raw material conveying pipe 112 may be fixed through the raw material conveying pipe flange 114, and the raw material input unit 110 may be connected to the first gasification unit 120 through the raw material input unit flange 115.

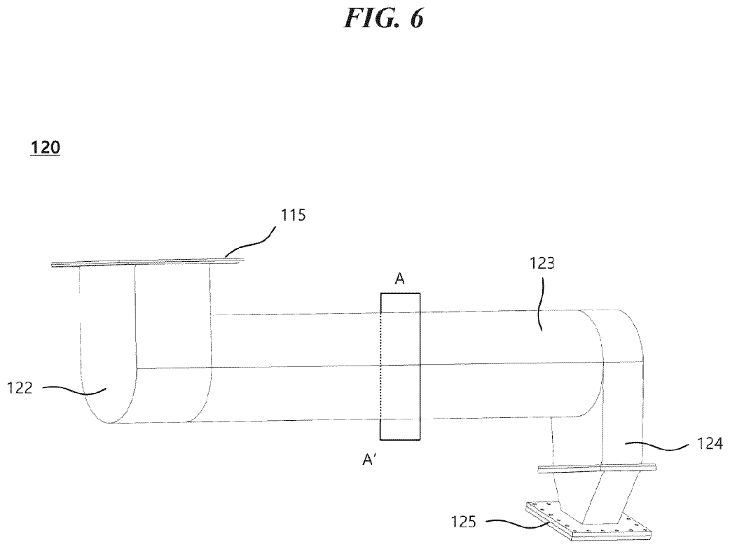

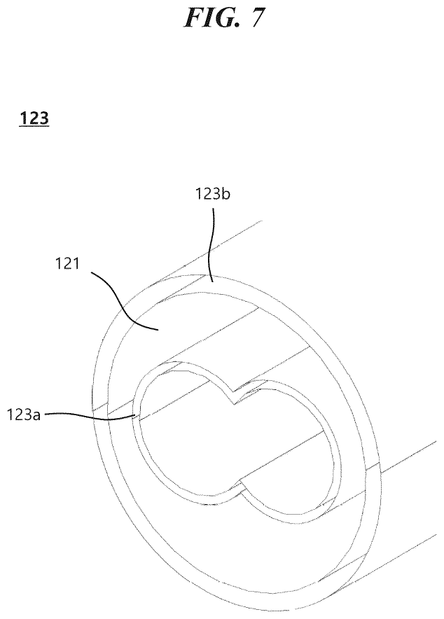

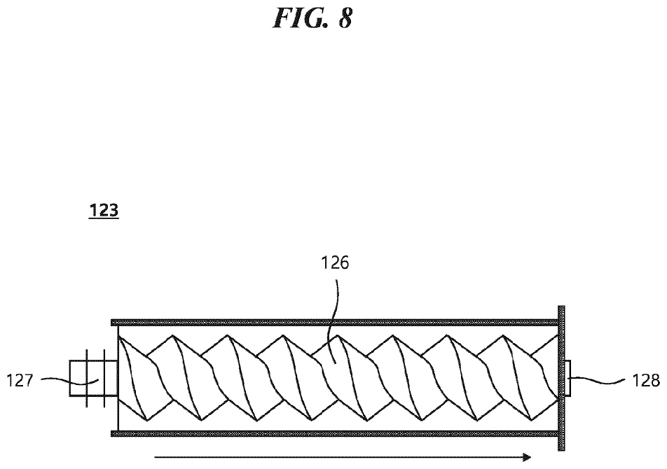

FIG. 6 is a diagram illustrating a first gasification unit according to an embodiment. FIG. 7 is a diagram illustrating a vertical cross-section of the first gasification unit according to an embodiment. FIG. 8 is a diagram illustrating a variable pitch screw device of the first gasification unit according to an embodiment. Herein, FIG. 7 is a diagram illustrating a cross section taken along line A-A′ of FIG. 6.

Referring to FIGS. 6 to 8, the first gasification unit 120 may include a first gasification unit input pipe 122, a first gasification reaction unit 123, a first gasification unit discharge pipe 124, and a first gasification unit flange 125.

The first gasification unit may include a variable pitch screw device 126 for constantly and continuously supplying and transporting waste plastic raw materials. The variable pitch screw device 126 may be disposed in a direction parallel to a transport direction of the waste plastic raw materials. In FIG. 7, a variable pitch screw case 123a is illustrated so that a pair of variable pitch screw devices 126 are disposed, without being limited thereto, and more variable pitch screw devices 126 may be disposed as needed.

The variable pitch screw device 126 may rotate through a variable pitch screw rotating unit 127 and transport waste plastic raw materials constantly and continuously. Additionally, the variable pitch screw device 126 may be fixed to a variable pitch screw fixing unit 128.

The variable pitch screw device 126 may be disposed inside the variable pitch screw case 123a, and based on the variable pitch screw case 123a, the waste plastic raw materials may move into the variable pitch screw case 123a, and the superheated steam 121 may move to the outside of the variable pitch screw case 123a. The moving directions of the waste plastic raw materials and the superheated steam 121 may be in opposite directions from each other. Thus, the waste plastic raw materials may be effectively pyrolyzed at low temperatures to produce a mixed gas.

Superheated steam 121 may be supplied to the first gasification unit 120 by reheating steam generated through a waste heat boiler burner. By reheating the steam and supplying the same to the first gasification unit 120, the superheated steam 121 may be stably and continuously injected. The superheated steam 121 supplied to the first gasification unit 120 may have a temperature of 600 to 700° C. Thus, the internal temperature of the first gasification 120 may be 350 to 450° C.

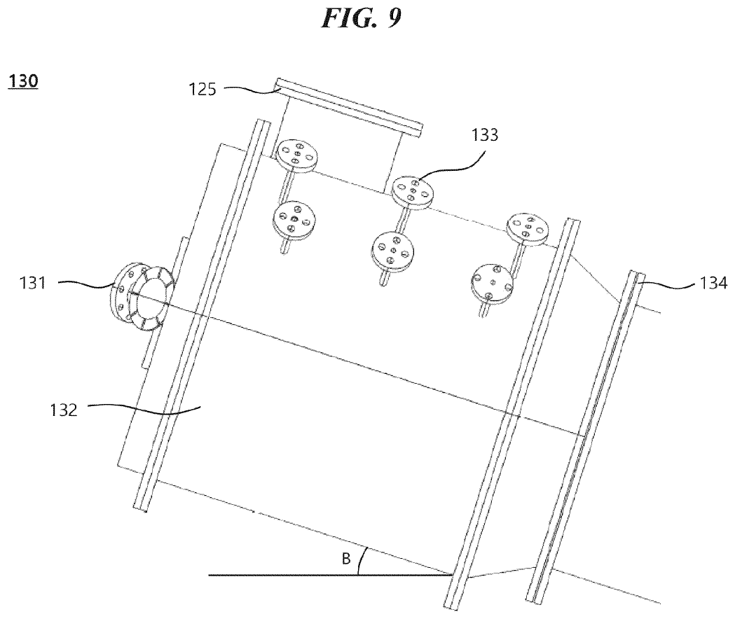

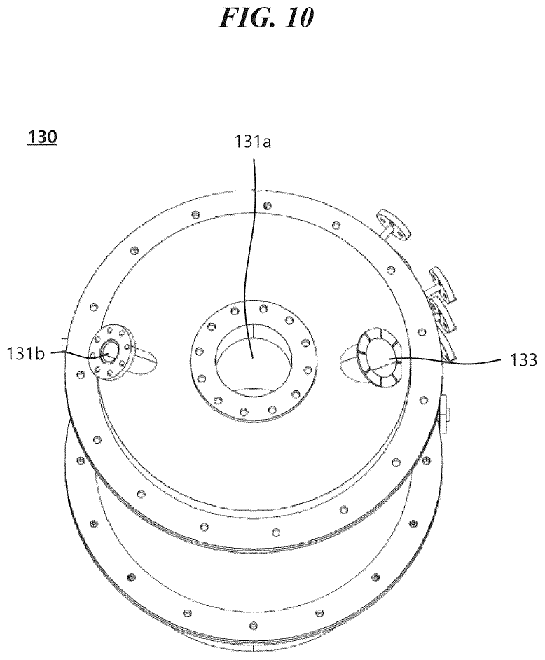

FIG. 9 is a diagram illustrating a side surface of a second gasification unit according to an embodiment. FIG. 10 is a diagram illustrating a front surface of the second gasification unit according to an embodiment.

Referring to FIGS. 9 and 10, the second gasification unit 130 may include a plasma torch 131, a second gasification reaction unit 132, a second gasification unit connection device 133, and a second gasification unit flange 134.

The second gasification unit 131 may gasify waste plastic raw materials using plasma. Herein, the second gasification unit 131 may generate plasma using the arc plasma device to supply heat energy to the inside of the second gasification unit 131.

The plasma torch 131 may be disposed on one side of the second gasification unit 131 to generate a flame inside the second gasification unit 131. The plasma torch 131 may include a main plasma torch 131a disposed at the center of one side of the second gasification unit 131 and an auxiliary burner 131b disposed next to the main plasma torch 131a. On the other side of the auxiliary burner 131b, the second gasification unit connection device 133 may be disposed to which an imaging device that may check the inside of the second gasification unit 130 may be connected.

The gasification reaction of the waste plastic raw materials may proceed in the second gasification reaction unit 132 due to the flame generated by the plasma torch 131. The second gasification unit 130 may be disposed with a plurality of second gasification unit connection devices 133 to control the internal conditions of the second gasification reaction unit 132 or to connect a plurality of devices for maintenance and repair.

The second gasification unit 130 may be connected to the residue discharge unit 140 through the second gasification unit flange 134.

In the case of gasification of waste plastics using plasma, when the heat energy supplied through plasma is not uniform, gasification of waste plastics may not proceed sufficiently locally and the efficiency may decrease. Accordingly, the second gasification unit 130 according to an embodiment of the present disclosure may be provided in a cylindrical shape so that the heat supplied from the arc plasma device may be uniformly distributed. Specifically, the second gasification unit 130 is a cylindrical cyclone type, and heat energy may be uniformly distributed throughout the second gasification reaction unit 132. In addition, the second gasification unit 130 is a cylindrical cyclone type, and the waste plastic raw materials may increase the residence time inside the second gasification reaction unit 132 to increase gasification efficiency.

The second gasification unit 130 may be disposed at an angle B of 15 to 25° with the ground surface. Thus, the waste plastic residual melt slag melted in the second gasification unit 130 may effectively move to the residue discharge unit, thereby performing continuous waste plastic gasification. When the angle B formed by the second gasification unit 130 with the ground surface is too low, it may be difficult for the waste plastic residual melt slag to be smoothly discharged to the residue discharge unit. When the angle B formed by the second gasification unit 130 with the ground surface is too large, the time the waste plastic raw materials stay inside the second gasification reaction unit 132 is reduced, which may reduce gasification efficiency.

The second gasification unit 130 supplies heat energy to the inside through a flame generated through the plasma torch 131, so that the internal temperature may be 1,200 to 1,500° C. Thus, most of the waste plastic raw materials may be gasified by high-temperature pyrolysis.

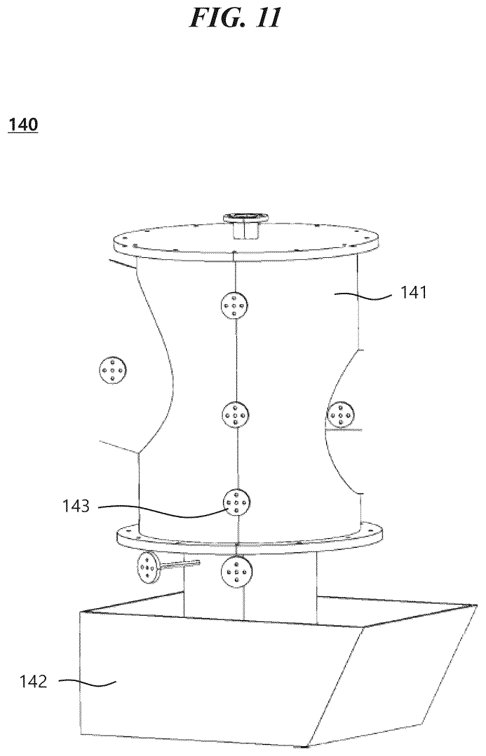

FIG. 11 is a diagram illustrating a residue discharge unit according to an embodiment.

Referring to FIG. 11, the residue discharge unit 140 may include a residue discharge pipe 141, a water tank 142, and a residue discharge unit connection device 143.

The residue discharge pipe 141 may transport the waste plastic residual melt slag melted in the second gasification unit 130 to the water tank 142 disposed at a lower portion of the residue discharge pipe 141. A plurality of residue discharge unit connection devices 143 may be disposed in the residue discharge pipe 141 to control internal conditions or connect a plurality of devices for maintenance and repair.

The water tank 142 for storing and discharging the waste plastic residual melt slag may be disposed at a lower portion of the residue discharge pipe 141. Cooling water for cooling the waste plastic residual melt slag may be stored inside the water tank 142. The cooling water not only cools the waste plastic residual melt slag stored inside the water tank 142 to room temperature, but also serves to block fluid from flowing into the second gasification unit 130.

The mixed gas generated in the first gasification unit 120 and the second gasification unit 130 may be transported to the heat exchange unit 150 connected to the second gasification 130 and cooled.

The heat exchange unit 150 may include a first heat exchanger 151, a second heat exchanger 152, and a third heat exchanger 153.

The first heat exchanger 151 may be disposed in a horizontal structure. Thus, it is possible to prevent deformation of heat exchanger equipment by effectively dispersing the heat energy transferred from the high-temperature mixed gas transported from the second gasification unit 130 utilizing high-temperature plasma. The mixed gas generated inside the second gasification 130 at 1,200 to 1,500° C. may be cooled to 400 to 600° C. by passing through the first heat exchanger 151.

The second heat exchanger 152 may be disposed in a vertical structure. Thus, the mixed gas may be cooled quickly and effectively. The mixed gas passing through the second heat exchanger 152 may be cooled to 80 to 100° C.

The third heat exchanger 153 may cool the mixed gas to 30 to 50° C. so that hydrogen collection may be performed smoothly before the mixed gas is transported to the hydrogen collection unit 160.

Next, a waste plastic gasification device according to another embodiment of the present disclosure will be described in detail.

The waste plastic gasification device 100 according to an embodiment may include: a raw material input unit for inputting waste plastic raw materials; a first gasification unit that pyrolyzes the raw materials at low temperatures using superheated steam to produce a mixed gas and preheats residual raw materials that have not been decomposed; a second gasification unit that further decomposes the preheated residual raw materials through plasma to produce the mixed gas; a residue discharge unit that stores and discharges waste plastic residual melt slag that has not been decomposed in the second gasification unit; and a heat exchange unit for cooling the mixed gas generated in the first gasification unit and the second gasification unit, wherein the second gasification unit is inclined in a direction of the residue discharge unit to discharge the waste plastic residual melt slag.

First, the details of the shapes of the raw material input unit, the first gasification unit, the residue discharge unit, the heat exchange unit, and the second gasification unit of the waste plastic gasification device 100 are the same as described above.

The second gasification unit of the waste plastic gasification device 100 may further decompose the preheated residual raw materials through the oxygen burner to produce a mixed gas.

Since the gasification reaction of waste plastics is an endothermic reaction, a continuous supply of heat energy is needed to efficiently proceed with the gasification reaction. In particular, it is essential to maintain a high temperature in the process of gasifying waste plastics. This is because converting waste plastics into gas through a gasification reaction requires a significant amount of energy to be absorbed during the reaction.

Various auxiliary heat source devices may be used to supply the heat energy needed for this gasification reaction. The waste plastic gasification device 100 according to an embodiment may include at least one of the plasma torch or the oxygen burner to supply heat energy needed for the gasification reaction of waste plastics.

Specific details about the plasma torch are the same as described above.

The oxygen burner is a device that generates a high-temperature flame by reacting pure oxygen and fuel. Using the oxygen burner, it is possible to obtain a flame at a much higher temperature than when using regular air. This is because the higher oxygen concentration increases combustion efficiency. The oxygen burner helps the gasification reaction proceed smoothly by providing the heat necessary for a waste plastic gasification reactor.

The oxygen burner uses at least one of LPG (liquefied petroleum gas) or LNG (liquefied natural gas) as fuel, and uses pure oxygen instead of general air as an oxidizing agent. As the oxygen concentration increases, the adiabatic flame temperature rises rapidly, reaching thousands of K or more. The high-temperature flame is very effective in gasifying waste plastics.

The waste plastic gasification device 100 according to an embodiment uses the oxygen burner, and may be used by mixing CO₂ with oxygen. When CO₂ is mixed with oxygen instead of nitrogen, CO₂ decomposes into CO and O₂ in a high-temperature flame. Accordingly, it is possible to provide a similar benefit as when using the plasma torch.

In particular, the waste plastic gasification device 100 according to an embodiment may recirculate CO₂ generated in the gasification process, mix the same with pure oxygen, and use the same as an oxidizing agent in the oxygen burner. Thus, CO₂ generated in the gasification process may be efficiently recycled, and the process may be operated without additional external CO₂ supply. This may contribute to reducing the environmental impact of the gasification process and improving economic feasibility.

Specifically, the composition of the mixed gas to be used as an oxidizing agent may range from using only O2 to mixing up to 75% of CO₂. By adjusting the CO₂ ratio as such, flame temperature and oxidation conditions may be optimized, thereby maximizing the efficiency of the gasification reaction. For example, the use of a high CO₂ ratio may lower the flame temperature appropriately to provide sufficient oxidant supply while maintaining reactor durability.

Additionally, the use of a mixture of CO₂ and O₂ helps control the oxidizing atmosphere in the reactor. CO₂ is an oxidizing agent and acts as an inert gas to a certain extent, and thus may improve the quality of the synthesis gas produced in the gasification process and prevent unnecessary introduction of nitrogen.

Accordingly, the waste plastic gasification device 100 according to an embodiment improves the efficiency of the gasification process while maintaining a high temperature and stable flame by using a mixture of CO₂ and O₂ as an oxidizing agent when the oxygen burner is used. Thus, an environmentally friendly and economical waste plastic gasification process may be implemented.

Next, a waste plastic gasification method according to another embodiment of the present disclosure will be described in detail.

The waste plastic gasification method according to an embodiment of the present disclosure may include: a raw material input stage of crushing waste plastic raw materials and inputting the same into a first gasification unit; a first gasification stage of pyrolyzing the input waste plastic raw materials at low temperatures using superheated steam in the first gasification unit; a second gasification stage of further decomposing residual raw materials that have not been decomposed in the first gasification stage through plasma in a second gasification unit; a residue discharge stage of storing and discharging waste plastic residual melt slag that has not been decomposed in the second gasification stage; and a hydrogen collection stage of extracting and collecting hydrogen from a mixed gas generated in the first gasification stage and the second gasification stage, wherein the waste plastic residual melt slag is transported to a residue discharge unit along an inclined direction of the second gasification unit.

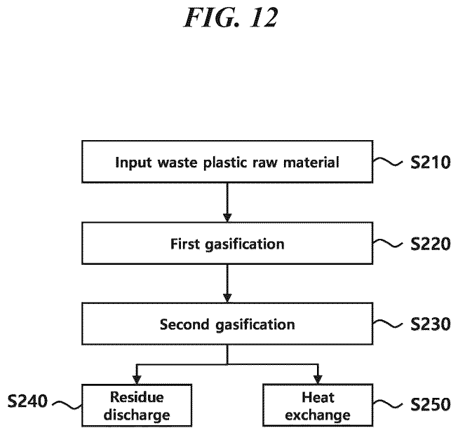

FIG. 12 is a flowchart of a waste plastic gasification method according to an embodiment.

Referring to FIG. 12, the waste plastic gasification method according to an embodiment of the present disclosure may include: a raw material input stage of crushing waste plastic raw materials and inputting the same into a first gasification unit (S210); a first gasification stage of pyrolyzing the input waste plastic raw materials at low temperatures using superheated steam in the first gasification unit (S220); a second gasification stage of further decomposing residual raw materials that have not been decomposed in the first gasification stage through plasma in a second gasification unit (S230); a residue discharge stage of storing and discharging waste plastic residual melt slag that has not been decomposed in the second gasification stage (S240); and a hydrogen collection stage of extracting and collecting hydrogen from a mixed gas generated in the first gasification stage and the second gasification stage (S250).

In the waste plastic raw material input stage (210), raw materials may be input into a gasification unit for gasifying waste plastic raw materials. The waste plastic raw materials may include thermoplastic and thermosetting plastics. Specifically, the waste plastic raw materials may include widely used plastics such as polyethylene (PE), polypropylene (PP), polystyrene (PS), and polyvinyl chloride (PVC).

In the waste plastic raw material input stage (S210), the waste plastic raw materials may be crushed through the crushing device. Thus, the waste plastics may be pulverized into fine particles and the reaction area in the gasification unit may be expanded to effectively gasify the waste plastics.

In the first gasification stage (S220), the waste plastic raw materials may be constantly and continuously supplied and subjected to low-temperature pyrolysis.

Specifically, in the first gasification stage (S220), a mixed gas may be produced by gasifying waste plastic raw materials using superheated steam. The superheated steam may have a temperature of 600 to 700° C. by reheating steam generated through a waste heat boiler burner. Since the superheated steam is supplied after being reheated, the temperature may be maintained constant and energy may be uniformly transferred to the first gasification unit 120 where the first gasification stage (S220) is performed. The first gasification stage (S220) may be performed at 350 to 450° C. using superheated steam at 600 to 700° C. In other words, in the first gasification stage (S220), the waste plastic raw materials are pyrolyzed at low temperatures, and thus 10 to 25% of the waste plastic raw materials may be gasified through the first gasification stage (S220).

In addition, in the first gasification stage (S220), waste plastic raw materials may be constantly and continuously supplied and pyrolyzed through the variable pitch screw device 126. The variable pitch screw device 126 may be disposed in a direction parallel to a transport direction of the waste plastic raw materials.

The variable pitch screw device 126 may be disposed inside the variable pitch screw case 123a, and based on the variable pitch screw case 123a, the waste plastic raw materials may move into the variable pitch screw case 123a, and the superheated steam 121 may move to the outside of the variable pitch screw case 123a. The moving directions of the waste plastic raw materials and the superheated steam 121 may be in opposite directions from each other. Thus, the waste plastic raw materials may be effectively pyrolyzed at low temperatures to produce a mixed gas.

The second gasification stage (S230) may produce a mixed gas by further decomposing the waste plastic residual raw materials that have not been decomposed in the first gasification stage (S220) through plasma. The plasma may be generated from an arc plasma device and transfer heat energy to the second gasification stage (S230). Thus, the second gasification stage (S230) may be performed at 1,200 to 1,500° C. Through the second gasification stage (S230), more than 75% of waste plastic raw materials may be gasified.

The second gasification unit 130, where the second gasification stage (S230) is performed, may be disposed in a shape inclined in the direction of the residue discharge unit 140 to facilitate the discharge of the waste plastic residual melt slag that remains without gasification. An embodiment of the present disclosure relates to a device capable of continuously supplying and gasifying the waste plastic raw materials, and it is important to continuously discharge the generated waste plastic residual melt slag. Accordingly, according to an embodiment of the present disclosure, the second gasification unit 130 may be disposed in an inclined shape so that waste plastic residual melt slag may be continuously discharged through the residue discharge unit 140.

In the residue discharge stage (S240), the waste plastic residual melt slag that has not been decomposed in the first gasification stage (S220) and the second gasification stage (S230) may be stored and discharged. In an embodiment of the present disclosure, since waste plastic raw materials are constantly and continuously input and gasified, the resulting waste plastic residual melt slag is continuously discharged through the residue discharge stage (S240).

The residue discharge stage (S240) may include a cooling stage of water cooling the waste plastic residual melt slag to room temperature using cooling water provided in the water tank. Thus, the waste plastic residual melt slag may be cooled and discharged to the outside. The inflow of air into the second gasification unit 130 from the outside may be blocked through the cooling water provided in the water tank 142.

The waste plastic residual melt slag discharged through the residue discharge stage (S240) is mostly an inorganic matter, and may be contained in 10% or less of waste plastic raw materials, preferably contained in 2 to 8% of the waste plastic raw materials, and more preferably contained in 5 to 7% of the waste plastic raw materials.

The heat exchange stage (S250) may include the first heat exchanger 151, which is a horizontal heat exchanger, the second heat exchanger 152, which is a vertical heat exchanger, and the auxiliary heat exchanger 153. Thus, the mixed gas may be cooled to 30 to 50° C., which is the optimal temperature for hydrogen collection.

Next, a waste plastic gasification system according to another embodiment of the present disclosure will be described in detail.

A waste plastic gasification system according to an embodiment of the present disclosure may include: a first gasification unit that pyrolyzes waste plastic raw materials at low temperatures using superheated steam to produce a mixed gas and preheats residual raw materials that have not been decomposed; a second gasification unit that further decomposes the preheated residual raw materials through plasma to produce the mixed gas; and a residue discharge unit that stores and discharges waste plastic residual melt slag that has not been decomposed in the second gasification unit.

The waste plastic raw materials may include widely used plastics such as polyethylene (PE), polypropylene (PP), polystyrene (PS), and polyvinyl chloride (PVC).

The first gasification unit 120 may produce a mixed gas by gasifying waste plastic raw materials using superheated steam 121. The superheated steam may have a temperature of 600 to 700° C. by reheating steam generated through a waste heat boiler burner. Since the superheated steam 121 is supplied after being reheated, the temperature may be maintained constant and energy may be uniformly transferred to the first gasification unit 120.

The first gasification unit may include the variable pitch screw device 126 for constantly and continuously supplying and transporting waste plastic raw materials. The variable pitch screw device 126 may be disposed in a direction parallel to a transport direction of the waste plastic raw materials.

The variable pitch screw device 126 may rotate through a variable pitch screw rotating unit 127 and transport waste plastic raw materials constantly and continuously. Additionally, the variable pitch screw device 126 may be fixed to a variable pitch screw fixing unit 128.

The variable pitch screw device 126 may be disposed inside the variable pitch screw case 123a, and based on the variable pitch screw case 123a, the waste plastic raw materials may move into the variable pitch screw case 123a, and the superheated steam 121 may move to the outside of the variable pitch screw case 123a. The moving directions of the waste plastic raw materials and the superheated steam 121 may be in opposite directions from each other. Thus, the waste plastic raw materials may be effectively pyrolyzed at low temperatures to produce a mixed gas.

The superheated steam 121 may have a temperature of 600° C. or higher, 625° C. or higher, and 650° C. or higher, and may have a temperature of 700°° C. or lower. Specifically, the superheated steam 121 may have a temperature of 600 to 700° C., and preferably may have a temperature of 699° C.

Heat energy is transferred into the first gasification unit 120 through the superheated steam of 600 to 700° C., and the internal temperature of the first gasification unit 120 may be 350 to 450° C. In other words, since the first gasification 120 pyrolyzes waste plastic raw materials at low temperatures, 10 to 25% of the waste plastic raw materials may be gasified through the first gasification unit 120.

The residual waste plastic raw materials remaining after being gasified in the first gasification unit 120 may not be in the form of fluff but in the form of compressed solids in which the volatile content has been partially decomposed. When these residual waste plastic raw materials are input into the second gasification unit 130 and gasified, suspended solids may be minimized. Moreover, it may be easy to intensively gasify intermediate residues in a high temperature area of the plasma torch flame and the high temperature area of the gasification furnace surface. Additionally, waste plastics that undergo primary thermal decomposition may reduce the energy needed for the secondary gasification reaction.

The second gasification unit 130 may produce a mixed gas by further decomposing the waste plastic residual raw materials that have not been decomposed in the first gasification unit 120 through plasma. Plasma may be generated from the arc plasma device to generate a flame inside the second gasification unit 130. Thus, the internal temperature of the second gasification unit 130 may be 1,200 to 1,500° C. More than 75% of waste plastic raw material may be gasified through the second gasification unit 130.

The internal temperature of the second gasification unit 130 through the flame generated from the arc plasma device may be 1,200°° C. or higher, 1,225°° C. or higher, 1,250° C. or higher, 1,275°° C. or higher, and 1,300° C. or higher, and 1,500° C. or lower, 1,475°° C. or lower, 1,450° C. or lower, 1,425° C. or lower, and 1,400° C. or lower. Preferably, the internal temperature of the second gasification unit 130 may be 1,300 to 1,400° C.

The second gasification unit may be inclined in the direction of the residue discharge unit to discharge the waste plastic residual melt slag.

The second gasification unit 130 may be disposed in a shape inclined in the direction of the residue discharge unit 140 to facilitate the discharge of waste plastic residual melt slag, which is residual inorganic matter remaining without gasification. An embodiment of the present disclosure relates to a device capable of continuously supplying and gasifying waste plastic raw materials, and it is important to continuously discharge the generated waste plastic residual melt slag. Accordingly, according to an embodiment of the present disclosure, the second gasification unit 130 may be disposed in an inclined shape so that waste plastic residual melt slag may be continuously discharged through the residue discharge unit 140.

The mixed gas produced in the first gasification unit 120 and the second gasification unit 130 may be carbon monoxide (CO), carbon dioxide (CO₂), methane (CH₄), and hydrogen (H₂).

The term “comprises,” “includes,” or “has” described above should be interpreted not to exclude other elements but to further include such other elements since the corresponding elements may be inherent unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted as coinciding with meanings of the related art from the context. It will be understood that terms should not be interpreted in an idealized or overly formal sense unless expressly so defined herein.

Hereinbefore, although the technical ideas of the present disclosure have been disclosed for illustrative purposes, a person having ordinary skill in the art to which the present disclosure pertains will appreciate that various modifications and variations are possible, without departing from the spirit and essential characteristics of the present disclosure. Therefore, the embodiments of the present disclosure are disclosed only for illustrative purposes and should not be construed as limiting the technical ideas of the present disclosure. The scope of protection of the present disclosure should be determined on the basis of the descriptions in the appended claims, and all technical ideas within the scope of equivalents thereof should be construed as being included in the scope of right of the present disclosure.

What is claimed is:

1. A waste plastic gasification device comprising:
a raw material input unit for inputting waste plastic raw materials;
a first gasification unit that pyrolyzes the waste plastic raw materials at low temperatures using superheated steam to produce a mixed gas and preheats residual raw materials that have not been decomposed;
a second gasification unit that further decomposes the preheated residual raw materials through plasma to produce the mixed gas;
a residue discharge unit that stores and discharges waste plastic residual melt slag that has not been decomposed in the second gasification unit; and
a heat exchange unit for cooling the mixed gas generated in the first gasification unit and the second gasification unit,
wherein the second gasification unit is inclined in a direction of the residue discharge unit to discharge the waste plastic residual melt slag.

2. The device of claim 1, wherein:
the raw material input unit comprises a hopper that stores the waste plastic raw materials; and
the hopper comprises a crushing unit that crushes the waste plastic raw materials.

3. The device of claim 1, wherein the first gasification unit comprises a variable pitch screw device for constantly and continuously supplying and transporting the waste plastic raw materials.

4. The device of claim 3, wherein the variable pitch screw device is disposed in a direction parallel to a transport direction of the waste plastic raw materials.

5. The device of claim 4, wherein the waste plastic raw materials move inside the variable pitch screw case, and the superheated steam moves outside the variable pitch screw case, wherein moving directions of the waste plastic raw materials and the superheated steam are in opposite directions from each other.

6. The device of claim 1, wherein the superheated steam is 600 to 700° C.

7. The device of claim 1, wherein the second gasification unit comprises an arc plasma device for supplying heat.

8. The device of claim 7, wherein the second gasification unit is provided in a cylindrical shape so that the heat supplied from the arc plasma device is uniformly distributed and is disposed at an angle of 15 to 25° with the ground surface.

9. The device of claim 7, wherein an internal temperature of the second gasification unit is 1,200 to 1,500° C.

10. The device of claim 1, wherein the residue discharge unit comprises a water tank storing cooling water for cooling the waste plastic residual melt slag that has not been decomposed in the second gasification unit.

11. The device of claim 1, wherein the second gasification unit recirculates and utilizes carbon dioxide (CO₂) contained in the mixed gas.

12. A waste plastic gasification device comprising:
a raw material input unit for inputting waste plastic raw materials;
a first gasification unit that pyrolyzes the waste plastic raw materials at low temperatures using superheated steam to produce a mixed gas and preheats residual raw materials that have not been decomposed;
a second gasification unit that further decomposes the preheated residual raw materials through an oxygen burner to produce the mixed gas;
a residue discharge unit that stores and discharges waste plastic residual melt slag that has not been decomposed in the second gasification unit; and
a heat exchange unit for cooling the mixed gas generated in the first gasification unit and the second gasification unit,
wherein the second gasification unit is inclined in a direction of the residue discharge unit to discharge the waste plastic residual melt slag.

13. The device of claim 12, wherein the second gasification unit recirculates and utilizes carbon dioxide (CO₂) contained in the mixed gas.

14. A waste plastic gasification method comprising:
a raw material input stage of crushing waste plastic raw materials and inputting the same into a first gasification unit;
a first gasification stage of pyrolyzing the input waste plastic raw materials at low temperatures using superheated steam in the first gasification unit and preheating residual raw materials that have not been decomposed;
a second gasification stage of further decomposing the preheated residual raw materials through plasma in a second gasification unit;
a residue discharge stage of storing and discharging waste plastic residual melt slag that has not been decomposed in the second gasification stage; and
a heat exchange stage of cooling a mixed gas generated in the first gasification stage and the second gasification stage,
wherein the waste plastic residual melt slag is transported to a residue discharge unit along an inclined direction of the second gasification unit.

15. The method of claim 14, wherein in the first gasification stage, the waste plastic raw materials are constantly and continuously supplied and subjected to low-temperature pyrolysis.

16. The method of claim 14, wherein the first gasification stage is performed at 350 to 450° C.

17. The method of claim 14, wherein the second gasification stage is performed at 1,200 to 1,500° C.

18. The method of claim 14, wherein the residue discharge stage comprises a cooling stage of water cooling the waste plastic residual melt slag to room temperature.

19. A waste plastic gasification system, comprising:
a first gasification unit that pyrolyzes waste plastic raw materials at low temperatures using superheated steam to produce a mixed gas and preheats residual raw materials that have not been decomposed;
a second gasification unit that further decomposes the preheated residual raw materials through plasma to produce the mixed gas; and
a residue discharge unit that stores and discharges waste plastic residual melt slag that has not been decomposed in the second gasification unit.

20. The system of claim 19, wherein the second gasification unit is inclined in a direction of the residue discharge unit to discharge the waste plastic residual melt slag.
